(19) United States
(12) Patent Application Publication
(10) Pub. No.: US 2011/0085482 A1
(43) Pub. Date: Apr. 14, 2011

(54) COMPUTER SYSTEM AND CONTROL METHOD THEREOF

(75) Inventors: Jung-sik YOON, Gyeonggi-do (KR); Kyoung-won KIM, Gyeonggi-do (KR)

(73) Assignee: SAMSUNG ELECTRONICS CO., LTD., Gyeonggi-Do (KR)

(21) Appl. No.: 12/845,097

(22) Filed: Jul. 28, 2010

(30) Foreign Application Priority Data
Oct. 13, 2009 (KR) 10-2009-0097136

(51) Int. Cl. G08C 17/00

(52) U.S. Cl. 370/311

(57) ABSTRACT

A computer system includes a system unit; a communication unit which performs a wireless network communication with a base station; and a controller that controls the communication unit to transmit a communication ending message if a shutdown event of the system unit occurs, and shuts down the system unit after the completion of the transmission of the message.

### CLAIM OF PRIORITY

This application claims, pursuant to 35 USC 119(a), priority to, and the benefit of the earlier filing date of, that Korean Patent Application No. 10-2009-0097136, filed on Oct. 13, 2009 in the Korean Intellectual Property Office, the disclosure of which is incorporated herein by reference.

### BACKGROUND

1. Field of Invention

The present invention is related to the field of wireless communications and more particularly to an apparatus and method for managing communication protocols in wireless communication systems to manage a communication network efficiently.

2. Description of the Related Art

In a conventional computer system, which includes a communication unit to perform a wireless network communication with a base station, a system unit is shut down before the communication unit ends communication with the base station upon an occurrence of a shutdown event of the system unit by a user. However, the base station continues to try to perform a network communication with the computer system without recognizing the ending of the communication with the computer system, thereby wasting a communication bandwidth.

### SUMMARY OF THE INVENTION

Accordingly, one or more exemplary embodiments of the invention described herein, provide a computer system and a control method thereof that transmits a wireless network communication ending message to a base station to prevent unnecessary waste of a communication bandwidth.

According to an aspect of an exemplary embodiment, there is provided a computer system including a system unit; a communication unit, which performs a wireless network communication with a base station; and a controller which controls the communication unit to transmit a communication ending message to the base station if a shutdown event of the system unit occurs, and shuts down the system unit after the completion of the transmission of the message.

The controller controls the communication unit to transmit the communication ending message after suspending the shutdown of the system unit.

The suspension of the shutdown of the system unit comprises suspending an ending of an application program by the controller.

The controller identifies whether the communication unit performs a wireless network communication with the base station.

The controller controls the communication unit to transmit the communication ending message after ending a communication connection application program if it is identified that the communication unit performs the wireless network communication.

The wireless network communication comprises, for example, a wireless wide area network (WWAN). However, it would be recognized that the invention described, herein, may be applicable to other types of wireless networks, whether long range or short range, and such applicability to the other types of networks has been considered and within the scope of the invention claimed. According to an aspect of another exemplary embodiment, there is a control method of a computer system comprising generating a shutdown event of a system unit of the computer system; transmitting a wireless network communication ending message to a base station by a communication unit; and shutting down the system unit if the transmission of the communication ending message is completed.

The generating of the shutdown event further comprises suspending the shutdown of the system unit.

The suspending the shutdown of the system unit comprises suspending an ending of an application program.

The control method further comprises identifying whether the communication unit performs a wireless network communication with the base station.

The control method further comprises ending a communication connection application program if the communication performs the wireless network communication.

The wireless network communication comprises a wireless wide area network (WWAN).

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a computer system according to an exemplary embodiment;

FIG. 2 illustrates a block diagram of a computer system according to an exemplary embodiment; and

FIG. 3 is a flowchart illustrating a control operation of the computer system according to an exemplary invention.

### DETAILED DESCRIPTION OF THE INVENTION

Exemplary embodiments of the invention will be described in detail with reference to the accompanying drawings so as to be understood and realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

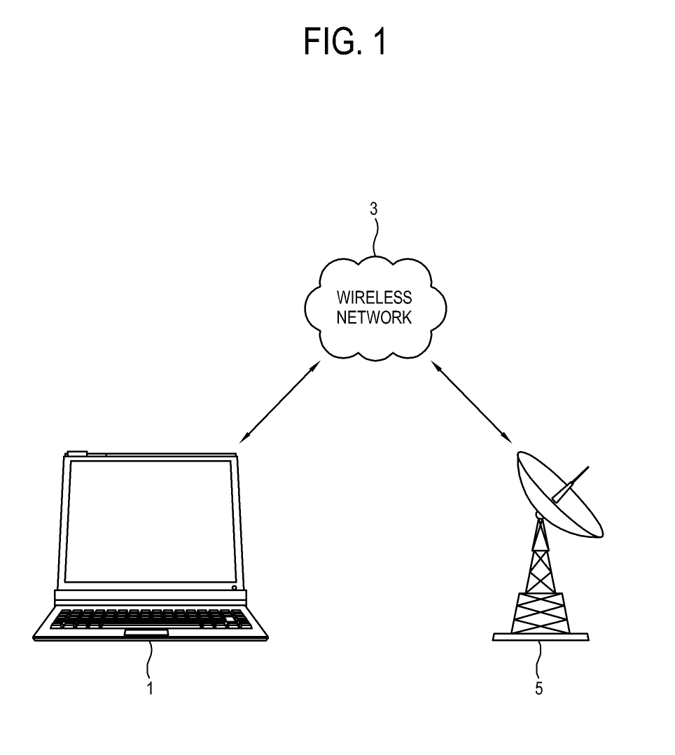

FIG. 1 illustrates a computer system 1 according to an exemplary embodiment of the present invention. The computer system 1 in FIG. 1 may include a laptop computer or a desktop computer. The computer system 1 according to the exemplary embodiment of the present invention may further include any device providing functions of a PC such as a smart book, a mobile Internet device (MID) or a netbook, as well as a typical PC. In addition, the computer system 1 may be a wireless communication device such as a cellular telephone, or similar devices that are capable of accessing a wireless communication service.

As shown therein, the computer system 1 communicates with a base station 5 which provides a wireless network communication service. That is, the wireless network communication means a wireless network communication between the computer system 1 and a mobile communication base station.

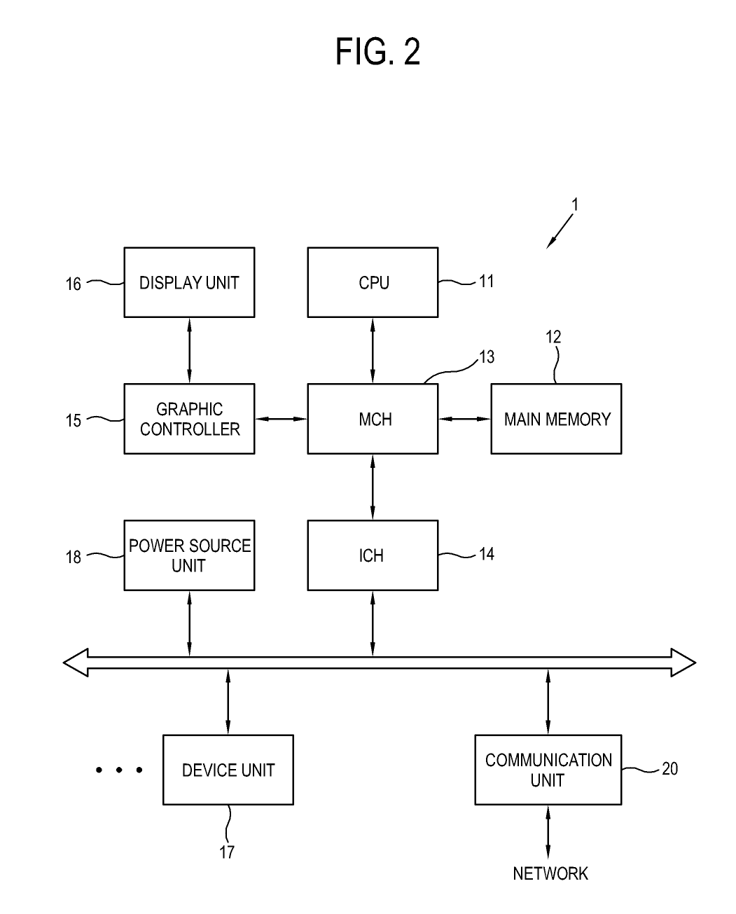

FIG. 2 is a block diagram of the computer system 1 according to the exemplary embodiment of the present invention.

As shown therein, the computer system 1 may include a central processing unit (CPU) 11, a main memory 12, a memory controller hub (MCH) 13, an input/output controller hub (ICH) 14, a graphic controller 15, a display unit 16 and at least one device unit 17.

The CPU 11 controls overall operation of the computer system 1 and executes a computer program that is loaded into the main memory 12. In executing the computer program, the CPU 11 may communicate with, and control the MCH 13, the ICH 14 and the device unit 17. The computer program, which is executed by the CPU 11, includes a basic input output system (BIOS), an operating system (OS) and an application. The BIOS, according to the present exemplary embodiment, may be stored in a storage unit such as a read only memory (ROM), such as the device unit 17, while the OS and application may be stored in a storage unit, such as a hard disk drive (HDD) or a solid state drive (SSD).

The application may include an application program that manages a connection of a wireless network communication by a communication unit 20 (to be described later) and an application program that manages a communication module of the communication unit 20, e.g., a wireless wide area network (WWAN) module.

The main memory 12 temporarily stores, therein, data on an operation of the CPU 11, including the computer program executed by the CPU 11. The main memory 12 is a volatile memory and may include, e.g., a double-data-rate synchronous dynamic random access memory (SDRAM).

The MCH 13 acts as an interface between elements of the CPU 11 and the main memory 12 for reading and writing data. The ICH 14 connects the CPU 11 and the device unit 17, and controls input and output of the device unit 17.

The graphic controller 15 processes graphic data to display an image. The display unit 16 displays an image thereon based on the graphic data processed by the graphic controller 15. The display unit 16 may include a liquid crystal display (LCD) or an organic light emitting diode (OLED). According to another exemplary embodiment, the computer system 1 such as a desktop computer may have an additional device, such as a monitor, as a display unit.

The device unit 17 is hardware with a predetermined function. The device unit 17 may include a mouse, a keyboard, an HDD (hard disk drive), an ODD (optical disk drive), a CD-ROM, a DVD-ROM, a USB (universal serial bus) drive, a network card, a sound card, a speaker or a microphone. For purposes of convenience, FIG. 2 illustrates only one device unit 17, but the computer system 1 according to the exemplary embodiment of the present invention may include a plurality of device units 17.

The computer system 1 according to the exemplary embodiment of the present invention may further include a power source unit 18 that supplies power to the elements of the computer system 1.

The computer system 1 according to the exemplary embodiment of the present invention further includes the communication unit 20. The communication unit 20 performs a wireless network communication 3 with the base station 5.

The wireless network communication 3 may include at least a WWAN. Accordingly, the communication unit 20 may include a WWAN module. The communication unit 20 may further include modules to support other types of wireless communication networks.

The WWAN utilizes a mobile communication terminal network technology for data transmission. For example, the WWAN may include 3G technology (i.e., communication protocols), such as WIMAX, UMTS, GPRS, CDMA2000, GSM, CDPD, Mobitex, HSDPA, WCDMA, CDMA2000Mx or EVDO. The WWAN may utilize LMDS and Wi-Fi to access the Internet.

The computer system 1 according to the exemplary embodiment of the present invention includes a system unit and a controller. The system unit according to the present exemplary embodiment performs a predetermined function for a user. For example, the system unit may include the graphic controller 15, the display unit 16, at least one device unit 17 or the power source unit 18 as in FIG. 2. According to another exemplary embodiment, the system unit may include the CPU 11 executing the OS and/or application.

The controller according to the exemplary embodiment of the present invention shuts down the system unit after the communication unit 20 transmits a communication ending message to the base station 5 upon an occurrence of the shutdown event of the system unit. For example, the controller may include the CPU 11 executing the BIOS.

In a conventional computer system, the controller ends all of the application programs in operation to prevent malfunction due to power-off, and cuts down power supplied to the computer system 1 after completing the shutdown process by the OS.

However, the controller according to the exemplary embodiment of the present invention executes a communication module management application upon an occurrence of a shutdown event of the system unit by a user. The communication module management application may suspend the shutdown of the system unit. That is, the communication module management application may suspend ending the application program by the OS. The controller may identify whether the communication unit 20 is connected to the wireless communication network. If it is identified that the communication unit 20 is connected to the communication network, the communication module management application may end the communication connection management application of the communication unit 20. Then, the controller controls the communication unit 20 to transmit the communication ending message to the base station 5. Otherwise, the controller may control the communication module management program to transmit the communication ending message to the communication unit 20.

After the communication unit 20 completes the transmission of the message, the controller resumes the shutdown of the system unit.

If the communication unit 20 is being connected to the communication network of the base station 5, and a user shuts down the system unit abruptly, the communication unit 20 suspends the communication. The base station 5 does not recognize the suspension of the communication and thus continues to transmit a signal to the communication unit 20 to resume the network communication. After all, the transmission of the signal to the communication unit 20 by the base station is an unnecessary effort, leading to a waste of a communication bandwidth. According to the present exemplary embodiment, however, thus if the shutdown event of the system unit occurs, the shutdown of the system unit is suspended and the communication unit 20 firstly transmits the communication ending message to the base station 5. Then, the base station 5 receives the message and ends the network communication, followed by the shutdown of the system unit. Accordingly, an unnecessary waste of the communication bandwidth may be prevented and the communication bandwidth may be used for communication between other computer systems and the base station 5.

If it is identified that the communication unit 20 is not connected to the communication network, the controller controls the communication unit 20 to transmit the communication ending message to the base station 5.

Thus, even if the communication unit 20 is not substantially connected to the communication network of the base station 5, the base station 5 continues to transmit a signal to be prepared for the commencement of the communication with the communication unit 20, thereby leading to the waste of the communication bandwidth. Accordingly, if the communication unit 20 transmits the communication ending message to the base station 5 and the base station 5 does not transmit the signal to resume the communication with the communication unit 20, the communication bandwidth is managed efficiently.

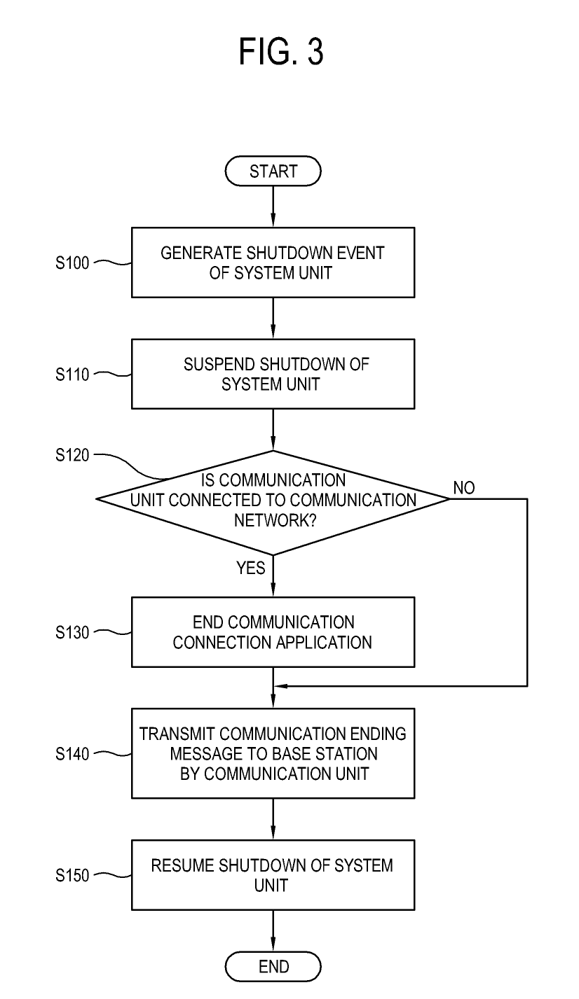

FIG. 3 is a flowchart of a control method of the computer system 1 according to an exemplary embodiment of the present invention.

The control method of the computer system 1 according to the exemplary embodiment of the present invention includes generating a shutdown event of the system unit of the computer system 1; transmitting the wireless network communication ending message by the communication unit 20 to the base station 5; and shutting down the system unit upon a completion of the transmission of the communication ending message.

The generating of the shutdown event may further include suspending the shutdown of the system unit.

The suspending of the shutdown of the system unit means ending an application program that may be running.

The control method may further include identifying whether the communication unit 20 performs the wireless network communication with the base station 5. If the communication unit 20 communicates with the base station 5, the control method may further include ending the communication connection application program. The wireless network communication may include the WWAN.

As shown in FIG. 3, if a user generates the shutdown event of the system unit (S100), the controller of the computer system 1 according to the exemplary embodiment of the present invention suspends the shutdown of the system unit (S110). The controller identifies whether the communication unit 20 is connected to the communication network (S120), and ends the communication connection management application in the event that the communication unit 20 is connected to the network (S130). The controller controls the communication unit 20 to transmit the communication ending message to the base station 5 (S140). After the transmission of the message is completed, the controller resumes the shutdown of the system unit (S150).

If the communication unit 20 is not connected to the communication network (S120), the controller controls the communication unit 20 to transmit the communication ending message to the base station 5 (S140). After the transmission of the message is completed, the controller resumes the shutdown of the system unit (S150).

As described above, a computer system and a control method thereof according to the exemplary embodiment transmits a wireless network communication ending message to a base station to prevent a continuous communication connection attempt to the computer system and a waste of a communication bandwidth and utilizes the communication bandwidth for communication with other computer systems.

The above-described methods according to the present invention can be realized in hardware or as software or computer code that can be stored in a recording medium such as a CD ROM, an RAM, a floppy disk, a hard disk, or a magneto-optical disk or downloaded over a network (i.e., The computer program can be provided from an external source which is electronically downloaded over a network, e.g., Internet, POTS, so that the methods described herein can be rendered in such software using a controller, a general purpose computer, or a special processor or in programmable or dedicated hardware, such as an ASIC or FPGA. As would be understood in the art, the controller, the computer, the processor or the programmable hardware include memory components, e.g., RAM, ROM, Flash, etc. that may store or receive software or computer code that when accessed and executed by the computer, processor or hardware implement the processing methods described herein. The code when loaded into a general purpose computer transformed the general purpose computer into a special purpose computer that may in part be dedicated to the processing shown herein. In addition, the computer, processor or dedicated hardware may be composed of at least one of a single processor, a multi-processor, and a multi-core processor.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A computer system, comprising:
a system unit;
a communication unit which performs a wireless network communication; and
a controller which controls the communication unit to transmit a communication ending message to a base station if a shutdown event of the system unit occurs, and shuts down the system unit after the completion of the transmission of the message.

2. The computer system according to claim 1, wherein the controller controls the communication unit to transmit the communication ending message after suspending the shutdown of the system unit.

3. The computer system according to claim 2, wherein the suspension of the shutdown of the system unit comprises suspending an ending of an application program by the controller.

4. The computer system according to claim 1, wherein the controller identifies whether the communication unit performs a wireless network communication.

5. The computer system according to claim 4, wherein the controller controls the communication unit to transmit the communication ending message after ending a communication connection application program if it is identified that the communication unit performs the wireless network communication.

6. The computer system according to claim 1, wherein the wireless network communication comprises a wireless wide area network (WWAN).

7. A control method of a computer system, the control method comprising:
generating a shutdown event of a system unit of the computer system;
transmitting a wireless network communication ending message by a communication unit; and
shutting down the system unit if the transmission of the communication ending message is completed.

8. The control method according to claim 7, wherein the generating of the shutdown event further comprises suspending the shutdown of the system unit.

9. The control method according to claim 8, wherein the suspending the shutdown of the system unit comprises suspending an ending of an application program.

10. The control method according to claim 7, further comprising identifying whether the communication unit performs a wireless network communication.

11. The control method according to claim 10, further comprising ending a communication connection application program if the communication performs the wireless network communication.

12. The control method according to claim 7, wherein the wireless network communication comprises a wireless wide area network (WWAN).

13. A portable terminal comprising:
a communication module;
a processor in communication with a memory, the memory including code, which when accessed by the processor causes the processor to:
detect a shutdown event,
determine whether an application program is running and suspend operation of ending the running application program in response to the shutdown event;
transmit a communication ending message through the communication module; and
complete the ending of the application program after the transmission of the communication ending message has been completed.

14. The terminal of clam 13, further comprising:
a display unit for displaying an image.

15. The terminal of claim 13, wherein the communication module processes at least one communication protocol selected from the group consisting of: WIMAX, UMTS, GPRS, CDMA2000, GSM, CDPD, Mobitex, HSDPA, WCDMA, CDMA2000Mx and EVDO.

16. A portable terminal comprising:
a communication module;
a processor in communication with a memory, the memory including code, which when accessed by the processor causes the processor to:
detect a shutdown event,
determine whether the portable device is connected to a network;
suspend ending of a running application program when the portable device is connected to the network;
transmit a communication ending message through the communication module; and
complete the ending of the application program after the transmission of the communication ending message has been completed.

17. The terminal of clam 16, further comprising:
a display unit for displaying an image.

18. The terminal of claim 16, wherein the communication module processes at least one communication protocol selected from the group consisting of: WIMAX, UMTS, GPRS, CDMA2000, GSM, CDPD, Mobitex, HSDPA, WCDMA, CDMA2000Mx and EVDO.
